(19) United States
(12) Patent Application Publication
(10) Pub. No.: US 2024/0341278 A1
(43) Pub. Date: Oct. 17, 2024

(54) PET TOY

(71) Applicant: TONGFU MANUFACTURING CO., LTD, Nanjing (CN)

(72) Inventors: Xiuxia SHEN, Nanjing (CN); Wen ZHANG, Nanjing (CN)

(73) Assignee: TONGFU MANUFACTURING CO., LTD, Nanjing (CN)

(21) Appl. No.: 18/321,010

(22) Filed: May 22, 2023

(30) Foreign Application Priority Data
Apr. 12, 2023 (CN) 202310388095.8

(51) Int. Cl. A01K 15/02

(52) U.S. Cl. CPC A01K 15/026

(57) ABSTRACT

A pet toy includes at least one toy body, and a mesh structure on an outer side of the toy body. The mesh structure is strong and durable, and avoids the breakup of the pet toy caused by the braided rope being bitten off by pets. In addition, the mesh structure can clean and protect the teeth of pets, and has good application value.

### CROSS REFERENCE TO THE RELATED APPLICATIONS

This application is based upon and claims priority to Chinese Patent Application No. 202310388095.8, filed on Apr. 12, 2023, the entire contents of which are incorporated herein by reference.

### TECHNICAL FIELD

The present disclosure belongs to the technical field of pet supplies, and specifically to a pet toy.

### BACKGROUND

With the popularity of pets, conventional pet toys are simple and boring, and can no longer meet the diversified needs on the market nowadays. As the entertainment level of pets increases, various pet supplies are developing rapidly. Pet toys allow pets to interact with their breeders to enhance the attachment of pets to breeders. Existing pet toys, such as training ropes, throwing ball ropes, soft toys for pets to scratch or bite, etc., are all twisted and woven from cotton materials or wool materials. Such pet toys have a loose structure, and once damaged, the whole toy will break up. Moreover, the existing pet toys do not have a function of cleaning teeth of pets, and their structures are monotonous, so pets are easy to lose interest in playing them. Therefore, it is necessary to develop a pet toy which is durable and cost-effective and can clean and protect the teeth of pets.

### SUMMARY

To overcome the drawbacks in the prior art, the present disclosure provides a pet toy. The pet toy includes at least one toy body, and a mesh structure on an outer side of the toy body. The mesh structure is strong and durable, and avoids the breakup of the pet toy caused by the braided rope being bitten off by pets. In addition, the mesh structure can clean and protect the teeth of pets, and has good application value.

The above technical objective of the present disclosure is attained with the following technical means.

The present disclosure provides a pet toy. The pet toy includes at least one toy body, and a mesh structure on an outer side of the at least one toy body.

Preferably, the mesh structure wraps the outer side of the at least one toy body entirely or partially.

Preferably, when the at least one toy body is made of a soft material, the mesh structure wraps the outer side of the at least one toy body by a mesh knot, or is sewn or adhered to the outer side of the at least one toy body; and

when the at least one toy body is made of a hard material, the mesh structure wraps the outer side of the at least one toy body by the mesh knot.

Preferably, when a number of the at least one toy body is at least two, the mesh structure is arranged in the following manner:
A: the mesh structure wraps all of the at least two toy bodies; or
B: the mesh structure wraps at least one of the at least two toy bodies, and the mesh structure is arranged or not arranged at any position on an outer side of other toy bodies; or
C: the mesh structure is arranged at any position on an outer side of all of the at least two toy bodies.

Preferably, when the number of the at least one toy body is at least two, every two adjacent toy bodies are separated by a mesh knot.

Preferably, a mesh hole perimeter of the mesh structure ranges from 40 mm to 75 mm.

Preferably, a braided wire diameter of the mesh structure ranges from 15 mm to 30 mm.

Preferably, a mesh hole shape of the mesh structure is configured into a shape as required.

Preferably, the mesh hole shape of the mesh structure includes square, rectangle, diamond, or ellipse.

Preferably, the mesh structure includes a knotted mesh structure and a knotless mesh structure.

Preferably, the knotless mesh structure includes a twisted knotless mesh structure and a warp-knitted knotless mesh structure.

Preferably, the knotted mesh structure is obtained by knot knitting, and is formed by hitch-knitting warp threads and weft threads in a shuttle.

The twisted knotless mesh structure is prepared by twisting two groups of yarns by a machine at the same time, and interweaving the two groups of the yarns at an intersection point to form a net.

The warp-knitted knotless mesh structure is prepared by loading warp yarns into a fishing net machine having four to eight guide bars, forming the warp yarns into loops, and interlinking the loops into a net.

Compared with the prior art, the present disclosure has the following advantages.

In the present disclosure, a fishing net or mesh structure is applied to the field of pet supplies for the first time, and a pet toy having the mesh structure is prepared for the first time. In the pet toy, a plurality of independent toy bodies not only can be put together in the mesh structure, but also can be separated by fishing net knots. Also, the mesh structure may wrap the outer side of a separate toy body or may wrap a part of the outer side of the toy body as an auxiliary part such as a hand or foot of a toy.

The mesh structure of the present disclosure can be used in a variety of modes, and is suitable for various toy bodies because the mesh structure is not of a fixed shape and has no restriction on the shape of the toy body. In addition, the mesh hole perimeter of the mesh structure of the present disclosure ranges from 40 mm to 75 mm, the braided wire diameter of the mesh structure ranges from 15 mm to 30 mm, and the hollow structure allows pets to see the toy body inside. The knitting mode of the mesh structure can make the pet toy not as loose in structure as existing pet toys woven by twisting a cotton material or wool material, and prevents the pet toy from breaking up even if a pet chews a hole in the mesh structure.

The mesh structure of the pet toy of the present disclosure can function as dental floss, and can clean and protect the teeth of pets while stimulating the fun of interaction between pets and people. The pet toy and the mesh structure both have the advantages of simple structures and low costs, and have good application value.

In the present disclosure, with the use of the mesh structure to wrap the toy body, pets can chew on the mesh structure conveniently, and the durability and firmness of the mesh structure can effectively prolong the service life of the pet toy. Furthermore, the toy body is convenient for a plurality of pets to compete together, which can increase the interest of the pet toy and prevents pets from losing interest in the pet toy. In addition, wrapping the toy body with the mesh structure can make the toy body looming in the mesh structure, thereby increasing the mystery of the toy and the curiosity of pets and stimulating the interest of pets in playing.

The mesh structure of the present disclosure may be prepared by knot knitting, warp knitting, and twisting. Weaving the mesh structure by warp knitting facilitates the specification change and provides high production efficiency. Weaving the mesh structure by twisting avoids the bending of yarns at the mesh nodes and provides flat netting.

### BRIEF DESCRIPTION OF THE DRAWINGS

FIG. 1 is a schematic structural diagram of a pet toy having only one toy body.

FIG. 2 is a schematic structural diagram of a pet toy having two toy bodies.

FIG. 3 is a schematic structural diagram of a pet toy having a mesh structure wrapping only part of a toy body.

FIG. 4 is a schematic structural diagram of a pet toy having a fish-shaped toy body.

### LIST OF REFERENCE NUMERALS

1—toy body; 2—mesh structure; 3—mesh knot.

### DETAILED DESCRIPTION OF THE EMBODIMENTS

The present disclosure will be further described in detail below with reference to drawings and embodiments, but the protection scope of the present disclosure is not limited thereto.

### Embodiment 1

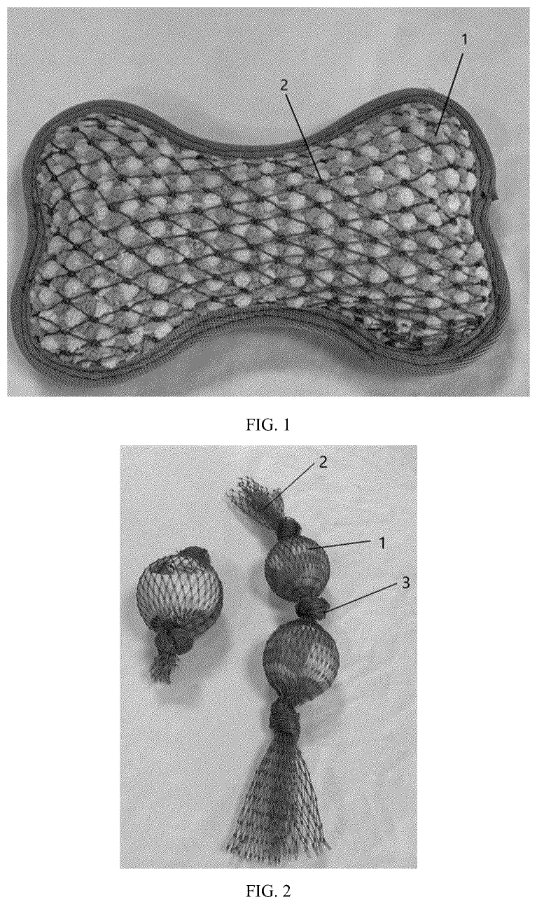

As shown in FIG. 1 to FIG. 4, the present disclosure provides a pet toy. The pet toy includes at least one toy body 1 and a mesh structure 2 on an outer side of the toy body 1. In a specific implementation process, the shapes and number of the at least one toy body 1 are arbitrarily set as required. For example, the at least one toy body 1 may be configured as one or more animals, balls, planar structures, foods and the like. The mesh structure 2 wraps on the outer side of the at least one toy body 1 by a mesh knot 3 or is sewn and fixed to the outer side of the at least one toy body 1.

As shown in FIG. 1 to FIG. 4, when the number of the at least one toy body 1 is at least two, the mesh structure 2 is arranged in any one of the following manners:
A: the mesh structure 2 wraps all of the at least two toy bodies 1; or
B: the mesh structure 2 wraps at least one of the at least two toy bodies 1, and the mesh structure 2 is arranged or not arranged at any position on the outer side of the other toy bodies 1; or
C: the mesh structure 2 is arranged at any position on the outer side of all of the at least two toy bodies 1.

When there is only one toy body 1, in a specific implementation, a design shown in FIG. 1 may be made. To be specific, there is only one toy body 1 and the mesh structure 2 wraps the whole toy body 1. In this case, the connection mode between the mesh structure 2 and the toy body 1 may be selected according to the material of the toy body 1. The mesh structure 2 and the toy body 1 can be sewn together, or the whole toy body 1 may be wrapped in the mesh structure 2 and fixed by a mesh knot 3.

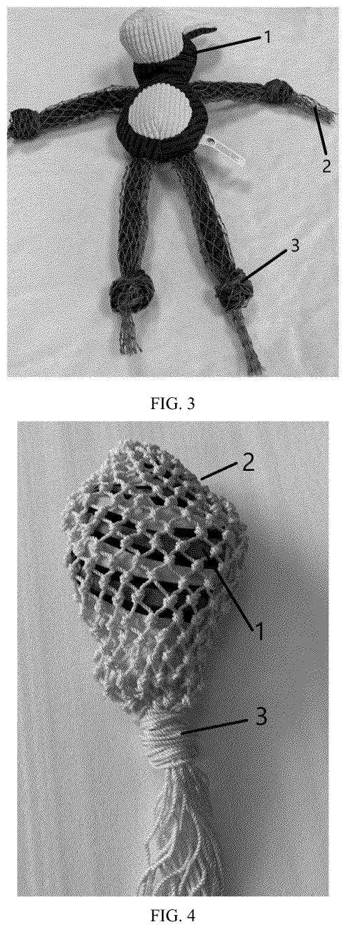

Alternatively, a design shown in FIG. 3 may be made. To be specific, the mesh structure 2 is only on part of the outer side of the toy body 1. In this case, the mesh structure 2 may be used as an accessory of the toy body 1, such as a hand or foot of the animal toy body 1.

Alternatively, a design shown in FIG. 4 may be made. To be specific, the mesh structure 2 wraps the outer side of the fish-shaped toy body 1, the mesh structure 2 is provided with a mesh knot 3 at the fish tail of the toy body 1, and the other end of the mesh knot 3 is provided with tassels.

When there are a plurality of toy bodies 1, in a specific implementation, a design shown in FIG. 2 may be made. To be specific, the mesh structure 2 is designed to be cylindrical, the plurality of toy bodies 1 are inserted into the cylindrical mesh structure 2, and adjacent toy bodies 1 are separated by a mesh knot 3 or other dividing members.

As shown in FIG. 1 to FIG. 4, a mesh hole perimeter of the mesh structure 2 ranges from 40 mm to 75 mm, and a braided wire diameter of the mesh structure 2 ranges from 15 mm to 30 mm. In a specific implementation, a mesh hole shape of the mesh structure 2 is configured into a shape as required, such as square, rectangle, diamond, or ellipse. The hollow structure allows pets to see the toy body 1 inside. The knitting mode of the mesh structure 2 can make the pet toy not as loose in structure as existing pet toys woven by twisting a cotton material or wool material, and prevents the pet toy from breaking up even if a pet chews a hole in the mesh structure.

In a specific implementation process, the mesh structure 2 includes a knotted mesh structure and a knotless mesh structure. The knotless mesh structure includes a twisted knotless mesh structure and a warp-knitted knotless mesh structure. The knotted mesh structure is obtained by knot knitting, and is formed by hitch-knitting warp threads and weft threads in a shuttle. The twisted knotless mesh structure is prepared by twisting two groups of yarns by a machine at the same time, and interweaving the two groups of the yarns at an intersection point to form a net. The warp-knitted knotless mesh structure is prepared by loading warp yarns into a fishing net machine having four to eight guide bars, forming the warp yarns into loops, and interlinking the loops into a net.

The embodiments are preferred embodiments of the present disclosure, but the present disclosure is not limited to the above-mentioned embodiments. Without departing from the spirit of the present disclosure, any obvious improvement, replacement or variation that can be made by the person skilled in the art belongs to the protection scope of the present disclosure.

What is claimed is:

1. A pet toy, comprising at least one toy body, and a mesh structure on an outer side of the at least one toy body.

2. The pet toy according to claim 1, wherein the mesh structure wraps the outer side of the at least one toy body entirely or partially.

3. The pet toy according to claim 2, wherein when the at least one toy body is made of a soft material, the mesh structure wraps the outer side of the at least one toy body by a mesh knot, or is sewn or adhered to the outer side of the at least one toy body; and
when the at least one toy body is made of a hard material, the mesh structure wraps the outer side of the at least one toy body by the mesh knot.

4. The pet toy according to claim 1, wherein when a number of the at least one toy body is at least two, the mesh structure is arranged in the following manner:
A: the mesh structure wraps all of the at least two toy bodies; or
B: the mesh structure wraps at least one of the at least two toy bodies, and the mesh structure is arranged or not arranged at any position on an outer side of other toy bodies; or
C: the mesh structure is arranged at any position on an outer side of all of the at least two toy bodies.

5. The pet toy according to claim 4, wherein when the number of the at least one toy body is at least two, every two adjacent toy bodies are separated by a mesh knot.

6. The pet toy according to claim 1, wherein a mesh hole perimeter of the mesh structure ranges from 40 mm to 75 mm.

7. The pet toy according to claim 1, wherein a braided wire diameter of the mesh structure ranges from 15 mm to 30 mm.

8. The pet toy according to claim 1, wherein a mesh hole shape of the mesh structure is configured into a shape as required.

9. The pet toy according to claim 8, wherein the mesh hole shape of the mesh structure comprises square, rectangle, diamond, or ellipse.

10. The pet toy according to claim 1, wherein the mesh structure comprises a knotted mesh structure and a knotless mesh structure.
